(19) United States
(12) Patent Application Publication
(10) Pub. No.: US 2008/0116294 A1
(43) Pub. Date: May 22, 2008

(54) SPRAY DEVICES AND NOZZLES

(75) Inventors: John Bragg, Goldsboro, NC (US); Gregory Meyer, Kinston, NC (US); Jerry Olesen, Elizabeth City, NC (US)

Correspondence Address: PEARNE & GORDON LLP, 1801 EAST 9TH STREET, SUITE 1200, CLEVELAND, OH, 44114-3108, US

(73) Assignee: Electrolux Home Products, Inc., Cleveland, OH (US)

(21) Appl. No.: 12/018,446

(22) Filed: Jan. 23, 2008

Related U.S. Application Data
(63) Continuation of application No. 11/032,886, filed on Jan. 10, 2005.
(60) Provisional application No. 60/558,180, filed on Mar. 31, 2004.

(51) Int. Cl. B05B 3/00; B08B 3/00

(52) U.S. Cl. 239/264; 134/57 D

(57) ABSTRACT

Spray devices for distributing a fluid include nozzles that are configured so that the fluid as it is discharged from the nozzles is disseminated into a spray pattern in the form of a sheet of fluid. In a particular aspect, the spray pattern is in the form of a three-dimensional sheet of the fluid. The spray devices that incorporate the nozzles can comprise rotatable spray arms for automatic dishwashers, including spray arms located above the upper racks of the dishwashers.

The benefit of provisional application Ser. No. 60/558,180, filed Mar. 31, 2004, and incorporated herein by reference is claimed for this application.

### FIELD OF THE INVENTION

### Background of the Invention

This invention relates generally to spray devices for distributing a fluid, such as spray arms for article washing devices and appliances, including dishwashers, and nozzles for such spray devices.

Spray devices for distributing fluids have a variety of applications. For example, article washing devices and appliances, such as dishwashers, often are provided with one or more rotatable spray arms that deliver a fluid such as water to the articles within the appliances as the spray arms rotate. The fluid provides a cleaning and/or rinsing action to the articles. In dishwashers, the spray arms can be located at one or more of the following locations: above an upper rack that holds articles to be washed; below a lower rack that holds articles to be washed; and between the upper and lower racks.

The rotatable spray devices may include one or more arms that extend substantially radially from the axis of rotation of the devices, and often the devices include two arms that extend outwardly from the axis of rotation of the devices in diametrically opposed directions. The arms of the rotatable spray devices are provided with apertures or nozzles of one type or another through which the fluid to be distributed is discharged. In the case of an article washing device, such as a dishwasher, the discharged fluid impinges upon the articles to be washed. The ejection of the fluid through the apertures typically imparts the force or torque required to rotate the rotatable spray device so that the fluid passing through the apertures or nozzles is distributed within the dishwasher as the spray device rotates. The fluid that is discharged is directed to the apertures in any number of ways. Typically, passageways that connect a means for supplying fluid under pressure with the apertures are provided in the arms of the rotatable spray devices.

The design of the apertures or nozzles in the rotatable spray devices influences the characteristics of the resulting streams of fluid emanating from the apertures or nozzles, their washing and/or rinsing effectiveness and certain operating requirements of the devices. For example, if the apertures or nozzles simply comprise relatively small circular openings in the arms of the rotatable spray devices so that only a narrow stream of fluid is generated from each aperture when the fluid is discharged therethrough, it is necessary to provide a large number of apertures to make certain that the fluid is widely distributed from the rotatable spray devices. In that case, it may be necessary to supply a large volume of water under high pressure to the apertures or nozzles.

### SUMMARY OF THE INVENTION

The present invention concerns devices or appliances, such as dishwashers, for washing articles wherein a spray device is provided for distributing a fluid within the appliance. The spray devices incorporate nozzles of a design that can provide for dissemination of the fluid under relatively low pressure while achieving maximum distribution or coverage of the fluid. As applied to a rotatable spray device in an article washing appliance such as a dishwasher, the nozzle designs of the invention allow for a reduction in the number of apertures or nozzles required to cover a given area of the interior of the dishwasher, provide for better control of the distribution or coverage of the fluid and reduce the hydraulic energy required to effectively wash the dishware. When the nozzle designs of the invention are incorporated into a dishwasher spray arm located above the uppermost rack in the dishwasher, cleaning of the articles in the upper rack is improved.

According to one aspect of the invention, an appliance or device for washing articles, such as a dishwasher, includes an enclosure for containing the articles to be washed, means for supplying a fluid under pressure and a spray device, such as a rotatable spray arm, for distributing the fluid to the articles located within the enclosure. The spray device is in fluid communication with the means for supplying fluid under pressure and has at least one arm that supports a first nozzle for distributing the fluid among the articles within the appliance. The first nozzle includes a first outlet from which the fluid is discharged. The first outlet is configured so that the fluid as it is discharged from the first outlet is disseminated into a spray pattern in the form of a three-dimensional sheet of the fluid. The term “sheet” as used herein means a relatively broad, thin object or continuum, that is, an object or continuum that is thin in comparison to its length and breadth, as will become apparent from the detailed description of the invention that is set forth below. Additionally, the phrase “three-dimensional sheet” means a sheet that is not flat or contained in only one plane, also as further described below in the detailed description of the invention.

According to a further aspect, the first outlet in the first nozzle includes a first outlet opening through which the fluid is discharged. The first outlet opening has a first end and a second end, the first end of the first outlet opening being wider than the second end. A confining surface is located opposite the first outlet opening for confining the fluid to the first outlet opening and the first nozzle is adapted to receive the fluid in a manner such that the fluid is directed from the first end of the first outlet opening to the second end of the first outlet opening. In particular aspects, the first outlet opening is incrementally and uniformly narrower in a direction from the first end of the first outlet opening to the second end of the first outlet opening and the confining surface is concave and generally conically-shaped. In yet another particular aspect, the first nozzle includes a concave generally cylindrically-shaped passageway that is joined to the first end of the confining surface so as to be in fluid communication with the first outlet.

According to another aspect of the invention, the first outlet of the first nozzle is configured so that the fluid as it is discharged from the first outlet is dispersed into a spray pattern generally in the form of a portion of a substantially hollow cone with the apex of the cone being located at the first outlet.

According to still another aspect of the invention, the first nozzle includes a second outlet from which the fluid is discharged. The second outlet is configured so that the fluid as it is discharged from the second outlet is disseminated into a spray pattern in the form of a substantially flat sheet of the fluid. The term “flat sheet” as used herein means a sheet that is substantially contained in a single plane as is further described below in the detailed description of the invention. In a particular aspect of the invention, the confining surface confines the fluid to the second outlet and the first nozzle is adapted to receive the fluid in a manner such that the fluid is directed from the first end of the first outlet opening to the second end of the first outlet opening and then to the second outlet opening.

In a further aspect, the first nozzle is located on an arm of a spray device, such as a rotatable spray device of a dishwasher at a first distance from the axis of rotation of the rotatable spray device and a first outlet in the first nozzle is arranged so that the fluid discharged from the first outlet is directed generally parallel to the axis of rotation of the rotatable spray device. The spray device is located adjacent the upper wall of the dishwasher enclosure above a rack for holding the articles that are to be washed. The first nozzle can also include the second outlet that is arranged and configured so that the fluid discharged from the second outlet is directed generally radially outwardly of the axis of rotation of the rotatable spray device so that the resulting spray pattern of the fluid from the second outlet, in the form of a substantially flat sheet of the fluid, and the axis of rotation of the rotatable spray device are located in substantially the same plane. The rack for holding the articles to be washed includes side shelves whereby the flat sheet of the fluid impinges on the articles to be washed that are located on those shelves.

In a further particular aspect, the rotatable spray device includes a second nozzle that is supported from the at least one arm a distance from the axis of rotation of the rotatable spray device a second distance that is less than the first distance at which the first nozzle is located. The second nozzle has a first outlet through which the fluid is directed generally parallel to the axis of rotation of the rotatable spray device, the first outlet of the second nozzle being configured so that the fluid is disseminated into a spray pattern in the form of a three-dimensional sheet of the fluid that is directed away from the at least one arm in substantially the same direction as the spray pattern from the first outlet in the first nozzle. The spray pattern can be in the form of a portion of a substantially hollow cone with the apex of the cone being located at the first outlet of the second nozzle.

According to a further aspect, the rotatable spray device includes a first arm and a second arm that extend outwardly of the axis of rotation of the rotatable spray device in substantially directly opposite directions. A first nozzle and second nozzle as described above are supported from one of the first and second arms. A third nozzle is supported from the other of the first and the second arms. The third nozzle has a first outlet through which the fluid is discharged, the first outlet in the third nozzle being configured and arranged so that the fluid as it is discharged from the first outlet of the third nozzle is directed generally parallel to the axis of rotation of the rotatable spray device and is disseminated into a spray pattern in the form of a three-dimensional sheet of the fluid that extends from the at least one arm in the same direction as the spray pattern from the second nozzle extends. In a particular aspect, each of the first outlet in the first nozzle, the first outlet in the second nozzle and the first outlet in the third nozzle is configured so that the fluid as it is discharged from each outlet is disseminated into a spray pattern generally in the form of a portion of a substantially hollow cone with the apex of the cone being located at a respective first outlet.

According to still another aspect, a fourth nozzle is supported from the same arm of the rotatable spray device as the third nozzle is supported, the fourth nozzle being located nearer the axis of rotation of the rotatable spray device than the third nozzle. The fourth nozzle has an outlet through which the fluid is discharged, the outlet in the fourth nozzle being configured so that the fluid that is discharged through the outlet is disseminated into a spray pattern in the form of a substantially flat sheet of the fluid. The outlet in the fourth nozzle is further configured so that the fluid discharged from the outlet is directed generally transversely of the axis of rotation of the rotatable spray device so that the spray pattern in the form of a substantially flat sheet of the fluid from the outlet in the fourth nozzle is located in a plane that intersects a plane containing both the axis of rotation of the rotatable spray device and the arm supporting the fourth nozzle at an angle of other than ninety degrees.

According to yet another aspect, the arms of the rotatable spray device include passageways that are in fluid communication with the nozzles for conducting the fluid to the nozzles.

### BRIEF DESCRIPTION OF THE DRAWINGS

FIG. 1 is a diagrammatic view of a dishwasher that embodies the present invention.

FIG. 2 is a perspective view of an embodiment of the rotatable spray device diagrammatically shown in FIG. 1 and that includes representations of the spray patterns formed upon the discharge of a liquid from the nozzles that are incorporated into the spray device.

FIG. 3 is a top view of the rotatable spray device illustrated in FIG. 2 and the spray patterns that emanate from the nozzles of the spray device.

FIG. 4 is a perspective view of a first type of nozzle incorporated in the rotatable spray arm of FIGS. 2 and 3.

FIG. 5 is a perspective view of a second type of nozzle incorporated in the rotatable spray arm of FIGS. 2 and 3.

### DETAILED DESCRIPTION OF AN EMBODIMENT OF THE INVENTION

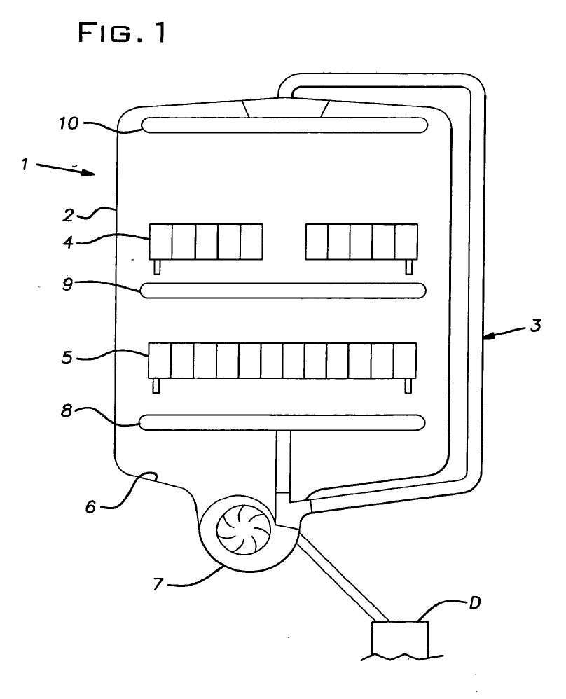

FIG. 1 schematically illustrates a dishwasher, indicated generally at 1, according to the present invention. The dishwasher 1 includes a washing enclosure or wash tub 2, a water distribution system 3 and upper and lower baskets or racks 4 and 5, respectively, for holding articles to be washed. The enclosure 2 typically is located within a cabinet (not shown) and has an open front side that is closed by a door (not shown). A bottom wall of the enclosure forms a reservoir or sump 6 for collecting washing fluid. The racks 4 and 5 are located for supporting articles to be washed such as, for example, dishes, silverware, glasses and cookware.

The water distribution system 3 includes a means for supplying a fluid under pressure in the form of a circulation pump 7 that is in fluid communication through appropriate valving with a first or lower level spray arm 8, a second or intermediate level spray arm 9 and a third or upper level spray arm 10 for delivering the washing fluid to the spray arms as will be understood by those skilled in the art. The circulation pump 7 also is in fluid communication with a drain pipe which delivers the washing fluid to the drain “D” through appropriate valving as will be understood by those skilled in the art.

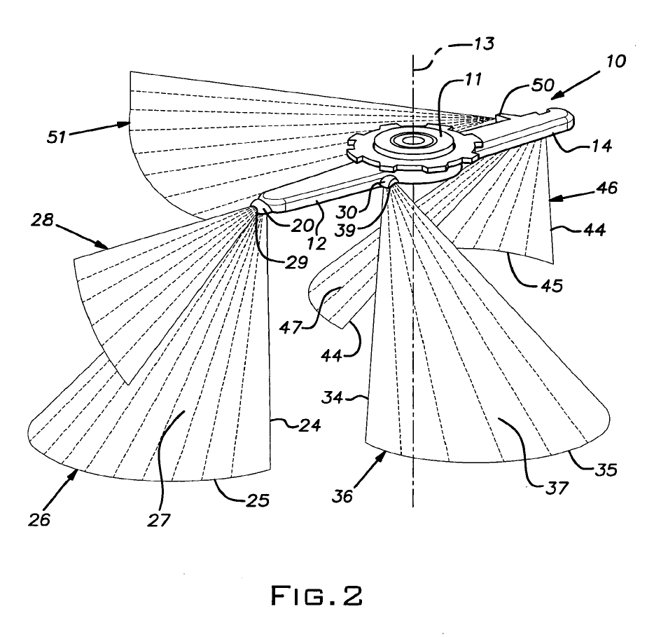

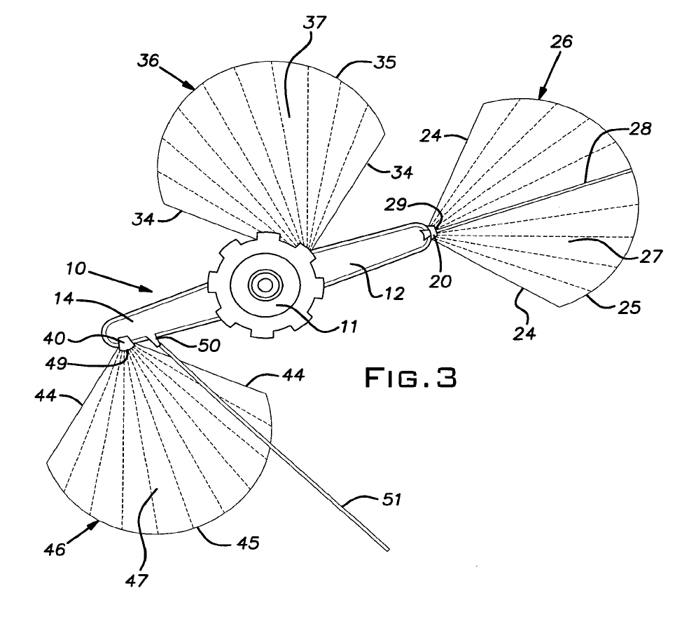

There is illustrated in FIGS. 2 and 3 an embodiment of the rotatable spray device of the invention schematically shown in FIG. 1. Specifically, as illustrated in the drawings, the rotatable spray device, indicated generally at 10, and associated fluid-disseminating nozzles, indicated at 20, 30, 40 and 50, are located above the upper rack 4 of the dishwasher. The utility of the spray device and the associated nozzles is not limited to dishwashers, however, and the spray device and nozzles can be used in other types of article washing appliances. Indeed, the rotatable spray device and nozzles can be used wherever it is desired to disseminate a fluid in spray patterns of the types established by the nozzles of the invention and their utility is not limited to article washing equipment. Further, the nozzles, can be used with other than a rotatable spray device. For example, the nozzles can be used separately for disseminating water from a source of water such as a shower head. Additionally, the nozzles can be used in an article washing apparatus where the nozzles are stationary and the articles to be washed are conducted through the fluid that is disseminated from the nozzles.

When incorporated in an automatic dishwasher, the spray device 10, and nozzles 20, 30, 40 and 50 that are adapted to receive the fluid that is to be discharged through the nozzles to the interior of the dishwasher, can be situated at various locations in the dishwasher. For example, the spray device can be located above the upper rack in the dishwasher that typically holds glassware in which case the fluid disseminated from the spray device is directed downwardly into the upper rack as illustrated in FIG. 1. The spray device can also be located between the upper rack 4 and the lower rack 5 of the dishwasher that typically holds dinnerware and pots and pans in which case the fluid disseminated from the spray device is directed downwardly into the lower rack and/or upwardly into the upper rack. In addition, the spray device can be located below the lower rack of the dishwasher in which case the fluid disseminated from the spray device is directed upwardly into the lower rack.

The embodiment of the spray device 10 illustrated in the drawings is particularly suitable for installation in an automatic dishwasher above the upper rack 4 of the dishwasher. For that purpose, the spray device includes a central hub 11 by means of which the spray device is adapted to be mounted for rotation about an axis of rotation 13 within the dishwasher. Specifically, the spray device is rotatably secured to the interior upper wall of the dishwasher in any suitable manner as is known to those skilled in the art whereby the spray device may rotate about its axis of rotation 13 and disseminate fluid within the dishwasher in a manner described further below. The fluid that is dispensed by the spray device during certain portions of the dishwashing cycle comprises a washing fluid and during other portions of the dishwashing cycle comprises a rinsing fluid, as will be familiar to those skilled in the art.

The spray device 10 comprises a first arm 12 and a second arm 14. In the embodiment of the invention illustrated in the drawings, each arm is connected to the hub 11 and extends substantially radially outwardly of the axis of rotation 13 of the spray device 10 in a substantially directly opposite direction from the other arm such that the angle between the arms is 180 degrees. Alternatively, each arm may extend outwardly of the axis of rotation such that the angle between them is other than 180 degrees.

In the embodiment of the invention illustrated in the drawings, there are four fluid disseminating nozzles: a first nozzle 20; a second nozzle 30; a third nozzle 40; and a fourth nozzle 50. The first nozzle, nozzle 20, and the second nozzle, nozzle 30, are supported from the first arm 12; and the third nozzle, nozzle 40, and the fourth nozzle, nozzle 50, are supported from the second arm 14 of the spray device.

Detailed descriptions of the four nozzles are set forth below and for present purposes it is sufficient to note that nozzle 20, the first nozzle, and nozzle 30, the second nozzle, each have a first outlet from which the fluid is discharged. In each case, the outlet is configured so that the fluid as it is discharged from the first outlet of each of nozzles 20 and 30 is disseminated into a spray pattern in the form of a three-dimensional sheet of the fluid. As noted above: the term “sheet” as used herein means an object or continuum that is thin in comparison to its length and breadth; and the phrase “three-dimensional sheet’ means a sheet that lies in other than a flat plane. In the embodiment of the invention illustrated in FIGS. 2 and 3, the first outlet of each nozzle 20 and 30 is configured so that the fluid as it is discharged from the first outlet is disseminated into a spray pattern in the form of a three-dimensional sheet of the fluid that comprises a portion of a substantially hollow cone 26 and 36, respectively, with the apex 29 of the cone 26 and the apex 39 of the cone 36 being located at the first outlet of a respective nozzle 20 and 30.

As best seen in FIG. 2, the first outlet in each of the first nozzle 20 and the second nozzle 30 is arranged so that the fluid discharged from the first outlet in each nozzle is directed generally parallel to the axis of rotation 13 of the rotatable spray device and is disseminated into a spray pattern in the form of a three-dimensional sheet of the fluid that extends away from the spray arm in the same direction as the spray pattern of the other nozzle. That is to say that, although the spray patterns 26 and 36 flare angularly outwardly of the axis of rotation 13 of the spray device 10 at 27 and 37, respectively, the spray patterns are more nearly parallel to the axis of rotation of the spray device than they are transverse to the axis of rotation. Consequently, the spray patterns 26 and 36 can be said to extend away from the arm 12 generally parallel to the axis of rotation 13 and in substantially the same direction. In the embodiment of the invention shown in the drawings, the direction in which the spray patterns 26 and 36 extend is downwardly from the spray device into the upper rack of the dishwasher. At the same time, in the embodiment of the invention illustrated in the drawings, the first nozzle 20 is located at a free end of the spray arm 12 a first distance from the axis of rotation 13 and is arranged so that the spray pattern 26 associated with the first nozzle tends to flare outwardly of the spray arm 12 at 27 in a radial direction from the axis of rotation 13 of the spray device while the second nozzle 30 is located on spray arm 12 a second distance from the axis of rotation 13 that is less than the first distance, and the second nozzle is arranged so that the spray pattern 36 associated with the second nozzle tends to flare outwardly of the spray arm 12 at 37 in a direction that is generally at approximately 90 degrees to the direction in which the spray pattern 26 associated with the first nozzle tends to flare outwardly at 27.

Because of the dissemination of the fluid from nozzles 20 and 30 as a sheet, it will be understood that wide-spread coverage of the articles underlying the nozzles is possible with relatively low volumes of water. Additionally, the three-dimensional character and, specifically, the conical shape of the spray patterns 26 and 36 of the fluid discharged from each of nozzles 20 and 30 provide for enhanced contact of the fluid with the underlying articles. Thus, for example, considering that the spray arm 10 will be rotating in a clockwise direction as viewed in FIGS. 2 and 3, the spray patterns 26 and 36 will impinge on articles underlying the spray patterns at various angles as the spray patterns pass over the articles. Consequently, although additional nozzles are provided in the embodiment of the invention shown in the drawings, complete and effective coverage of the articles underlying the spray device can be had using only the nozzles 20 and 30.

In order to provide for effective fluid coverage to additional articles held in the upper rack of the dishwasher, the first nozzle 20 also includes a second outlet from which the fluid is discharged. The upper rack in many dishwashers includes at least one shelf that is located along the side of and above the bottom of the rack and the fluid emanating from the second outlet of the first nozzle 20 will effectively impinge on and wash and rinse any articles located on such a shelf. A detailed description of the second outlet is set forth below. It is noted here, however, that the second outlet is configured so that the fluid as it is disseminated from the second outlet is dispersed into a spray pattern in the form of a substantially flat sheet of the fluid 28 as best seen in FIG. 2. In the embodiment of the invention shown in the drawings, the second outlet in the first nozzle 20, additionally, is arranged and configured in a manner such that the fluid discharged from the second outlet is directed generally radially outwardly of the axis of rotation 13 of the spray device 10 so that the spray pattern in the form of the substantially flat sheet of the fluid 28 from the second outlet and the axis of rotation 13 of the rotatable spray device are located in substantially the same plane as is best seen in FIG. 3.

As shown in FIGS. 2 and 3, the third nozzle 40 is located on the spray arm 14 adjacent the free end of the spray arm 14. The construction of the third nozzle 40 is similar to the construction of the second nozzle 30. In other words, the third nozzle 40 has a first outlet through which the fluid is discharged and the first outlet in the third nozzle is configured and arranged so that the fluid that is discharged through the first outlet in the third nozzle is discharged generally parallel to the axis of rotation of the rotatable spray device and is disseminated into a spray pattern in the form of a three-dimensional sheet of the fluid that extends away from the spray device in substantially the same direction as the spray pattern from each of the first outlets in the first and second nozzles, 20 and 30 respectively, extends. As with the first outlet in each of the first nozzle 20 and the second nozzle 30, the first outlet in the third nozzle 40 is configured so that the fluid as it is discharged from the first outlet of nozzle 40 is disseminated into a spray pattern generally in the form of a portion of a substantially hollow cone 46 with the apex 49 of the cone being located at the first outlet of the nozzle 40. Also, as with the second nozzle 30, the spray pattern 46 associated with the third nozzle tends to flare outwardly of the spray arm at 47 in a direction that is generally at approximately 90 degrees to the direction in which the spray pattern 26 associated with the first nozzle tends to flare outwardly at 27. However as can be seen in the drawings, the spray pattern 36 emanating from the second nozzle 30 flares outwardly at 37 in one direction while the spray pattern 46 emanating from the third nozzle 40 flares outwardly at 47 in the opposite direction.

The characteristics of the spray patterns 26, 36 and 46, insofar as they each similarly comprise in general a portion of a substantially hollow cone with the apex 29, 39 and 49, respectively, of the cone being located at the respective outlets of the nozzles from which the spray patterns emanate, is best illustrated with reference to FIG. 2. Specifically, spray pattern 26 has a directrix 25, spray pattern 36 has a directrix 35 and spray pattern 46 has a directrix 45. Additionally, spray pattern 26 has terminal lateral edges 24, spray pattern 36 has terminal lateral edges 34 and spray pattern 46 has terminal lateral edges 44.

The rotatable spray device 10 includes a fourth nozzle 50 that is supported from the second arm 14 of the spray device, the same arm of the rotatable spray device from which the third nozzle 40 is supported. The fourth nozzle 50 is located nearer the axis of rotation 13 of the rotatable spray device 10 than the third nozzle 40 in the embodiment of the invention shown in the drawings. The fourth nozzle 50 has an outlet, not shown, through which the fluid is discharged, the outlet in the fourth nozzle being configured so that the fluid that is discharged through the outlet is disseminated into a spray pattern in the form of a substantially flat sheet 51 of the fluid. The outlet in the fourth nozzle 50 is further configured and the fourth nozzle arranged so that the fluid discharged from the outlet in the fourth nozzle is discharged generally transversely of the radial aspect of the axis of rotation 13 of the rotatable spray device that extends along arm 14 so that the spray pattern in the form of the substantially flat sheet 51 of the fluid is located in a plane that intersects at an angle of other than ninety degrees a plane containing both the axis of rotation 13 of the rotatable spray device and the arm 14 supporting the fourth nozzle. As with the spray pattern 28 established by the second outlet of the first nozzle 20, the substantially flat sheet 51 of the fluid from the outlet in the fourth nozzle 50 will impinge on any articles located on a shelf along one or more sides of the upper rack of the dishwasher. Additionally, because the substantially flat sheet 51 of the fluid from the outlet in the fourth nozzle 50 is located in a plane that intersects a plane containing both the axis of rotation 13 of the rotatable spray device 10 and the arm 14 supporting the fourth nozzle 50 at an angle of other than ninety degrees, the expulsion of the fluid through the fourth nozzle 50 will provide a positive driving force to cause the spray device 10 to rotate in a clockwise direction as viewed in FIGS. 2 and 3.

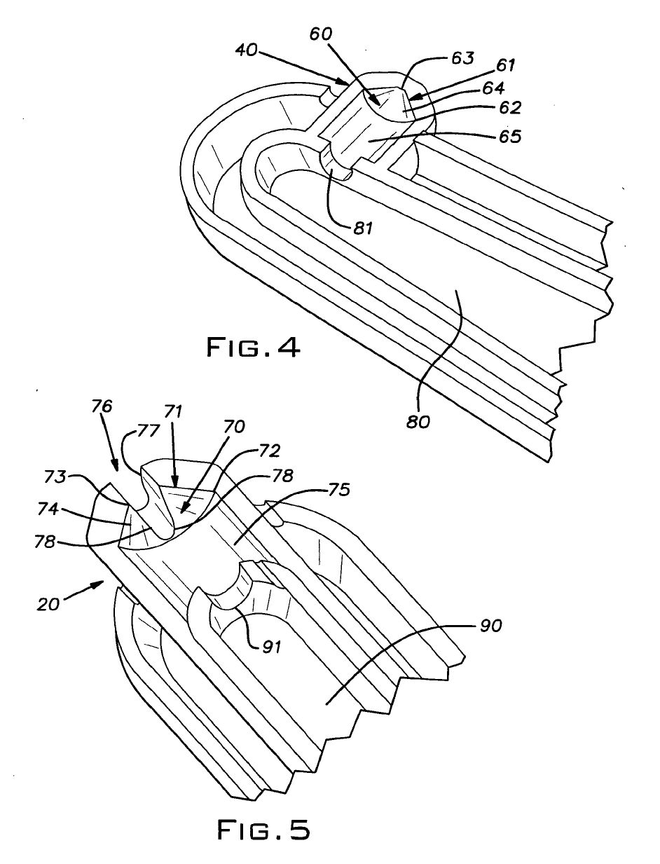

Reference will now be made to FIGS. 4 and 5 for a detailed description of the first, second and third nozzles. The first nozzle 20 is illustrated in FIG. 5 from the underside of arm 12 and the third nozzle 40 is illustrated in FIG. 3 from the underside of arm 14. Turning first to FIG. 4, the third nozzle 40, which is supported from the second arm 14 of the rotatable spray device 10 adjacent a free end of the arm, includes a first outlet 60 from which the fluid is discharged. The first outlet in the third nozzle 40 includes a first outlet opening 61 through which the fluid is discharged so as to be disseminated into a spray pattern in the form of the three-dimensional sheet of the fluid, or more specifically, a spray pattern 46 generally in the form of a portion of a substantially hollow cone with the apex 49 of the cone being located at the first outlet 60.

The first outlet opening 61 has a first end 62 and a second end 63, the first end of the first outlet opening being wider than the second end of the first outlet opening. A confining surface 64 that is concave and generally conically shaped is located opposite the first outlet opening 61 for confining the fluid to the first outlet opening. In the embodiment of the invention shown in the drawings, the first outlet opening 61 is incrementally and uniformly narrower in a direction from the first end 62 of the first outlet opening to the second end 63 of the first outlet opening and the third nozzle 40 is adapted to receive the fluid in a manner such that the fluid is directed from the first end 62 of the first outlet opening to the second end 63 of the first outlet opening. In this regard, a passageway 80 is provided in arm 14 for conducting the fluid from the center of the spray device at hub 11 to the nozzle 40. Access to the nozzle 40 for the fluid is provided by means of an opening 81 in a wall of the passageway 80. Although not required, the third nozzle 40 can include a concave generally cylindrically-shaped entryway 65 that is joined to the first end 62 of the confining surface 64 so as to be in fluid communication with the first outlet 60. It is to be understood, as will be appreciated by those skilled in the art, that a suitable cover is located over the passageway 80 so that the fluid is confined to the passageway as it is conducted to the opening 81.

From the foregoing description, it will be understood that as the fluid passes through the opening 81 it will be under sufficient force to be directed through the entryway 65 and into the first outlet 60 in the third nozzle 40 from where the fluid is discharged through the first outlet opening 61 in the first outlet 60 of the third nozzle 40 in a direction generally parallel to the axis of rotation 13 of the rotatable spray device 10 as was discussed above. It will also be understood that the fluid as it is discharged through the first outlet opening 61 is disseminated into a spray pattern in the form of a three-dimensional sheet of the fluid. More specifically, the fluid as it is discharged through the first outlet opening 61 is disseminated into a spray pattern 46 generally in the form of a portion of a substantially hollow cone with the apex 49 of the cone being located at the first outlet opening 61.

The construction of the second nozzle 30 is essentially the same as the construction of the third nozzle 40 so that the spray pattern 36 developed by the dissemination of the fluid discharged from the first outlet of the second nozzle 30 will be similar to the spray pattern 46 emanating from the third nozzle 40. The second nozzle 30 can include a concave generally cylindrically-shaped entryway similar to the entryway 65 of the third nozzle 40 that is in fluid communication with the first outlet in the second nozzle 20. Additionally, the spray arm 12 from which the second nozzle 40 is supported has a passageway that is similar to the passageway 80 in the spray arm 14 and an opening is provided in a wall of the passageway at the point at which the second nozzle 30 is attached to the arm 12 to provide access for the fluid to the outlet of the second nozzle 30 from the passageway through the entryway in the nozzle 30 that is in fluid communication with the first outlet in the second nozzle 30. Consequently, the details of the construction of the second nozzle 30 and its attachment to the arm 12 are not shown. Although the construction of the second and third nozzles is similar, the nozzles are supported from the rotatable spray device 10 at different locations. As noted above, the third nozzle 40 is located adjacent the free end of the second arm 14 whereas the second nozzle 30 is located on the first, or other, arm 12 of the spray device 10 adjacent the rotational axis 13 of the spray device.

From the foregoing description, it will be understood that as the fluid enters the nozzle 30 it will be under sufficient force to be directed through the entryway of the nozzle 30 and into the first outlet in the second nozzle from where it is discharged through the first outlet opening in the first outlet of nozzle 30 in a direction generally parallel to the axis of rotation of the rotatable spray device. It will also be understood that the fluid as it is discharged through the first outlet opening of the second nozzle 30 is dispersed into a spray pattern in the form of a three-dimensional sheet of the fluid. More specifically, the fluid as it is discharged through the first outlet opening of the second nozzle 30 is disseminated into a spray pattern 36 generally in the form of a portion of a substantially hollow cone with the apex 39 of the cone being located at the first outlet opening of the second nozzle 30.

Turning now to FIG. 5, the construction of the first nozzle 20 is shown. The first nozzle 20 includes a first outlet 70 from which the fluid is discharged. The first outlet 70 in the first nozzle 20 includes a first outlet opening 71 through which the fluid is discharged so as to be disseminated into a spray pattern in the form of a three-dimensional sheet of the fluid, or more specifically, a spray pattern 26 generally in the form of a portion of a substantially hollow cone with the apex 29 of the cone being located at the first outlet 70.

The first outlet opening 71 of the first nozzle 20 has a first end 72 and a second end 73, the first end 72 of the first outlet opening 71 being wider than the second end 73 of the first outlet opening 71. A confining surface 74 is located opposite the first outlet opening 71 for confining the fluid to the first outlet opening. In the embodiment of the invention shown in the drawings, the first outlet opening 71 of the first nozzle 20 is incrementally and uniformly narrower in a direction from the first end 72 of the first outlet opening 71 to the second end 73 of the first outlet opening 71. Additionally, the confining surface 74 is concave and generally conically shaped. Although not required, the first nozzle 20 can include a concave generally cylindrically-shaped entryway 75 that is joined to the first end 72 of the first outlet opening 72 so as to be in fluid communication with the first outlet 71.

A passageway 90 is provided in arm 12 for conducting the fluid from the center of the spray device at hub 11 to the first nozzle 20. Access to the nozzle 20 for the fluid is provided by means of an opening 91 in a wall of the passageway.

From the foregoing description, it will be understood that as the fluid enters the first nozzle 20 it will be under sufficient force to be directed through the entryway 75 of the first nozzle and into the first outlet 70 in the first nozzle from where it is discharged through the first outlet opening 71 in the first outlet 70 of the first nozzle 30 in a direction generally parallel to the axis of rotation of the rotatable spray device. It will also be understood that the fluid as it is discharged through the first outlet opening 71 of the first nozzle 30 is disseminated into a spray pattern in the form of a three-dimensional sheet of the fluid. More specifically, the fluid as it is discharged through the first outlet opening 71 of the first nozzle 30 is disseminated into a spray pattern 26 generally in the form of a portion of a substantially hollow cone with the apex 29 of the cone being located at the first outlet opening 71 of the first nozzle 20.

To this point, the description of the first nozzle 20 has been largely similar to that of the third nozzle 40 shown in FIG. 4. The first nozzle 20, however, includes a second outlet 76 including a second outlet opening 77 through which the fluid is also discharged. The second outlet 76 is located at the second end 73 of the first outlet opening 71 and the confining surface 74 confines the fluid to the first outlet opening 71 and the second outlet opening 77 in the first nozzle 20. The second outlet 76 is configured so that the fluid as it is discharged from the second outlet 76 and through the second outlet opening 77 is disseminated into a spray pattern 28 in the form of a substantially flat sheet of the fluid as best seen in FIG. 2. Specifically, the second outlet opening 77 in the first nozzle 20 comprises an elongated slot having substantially parallel sides 78, the slot extending downwardly through the concave conical confining surface 74 at the narrower end 73 of the first outlet opening 71 in the first nozzle 20. In the case of the first nozzle 20, the nozzle is adapted to receive the fluid in a manner such that the fluid is directed from the first end 72 of the first outlet opening 71 to the second end 73 of the first outlet opening 71 and then to the second outlet 76 and second outlet opening 77.

In the embodiment of the invention shown in the drawings, the second outlet 76 in the first nozzle 20 is arranged and configured in a manner such that the fluid discharged from the second outlet 76 through the second opening 77 is directed generally radially outwardly of the axis of rotation 13 of the spray device 10 so that the spray pattern 28 in the form of the substantially flat sheet of the fluid and the axis of rotation 13 of the rotatable spray device are located in substantially the same plane.

As indicated above, the fourth nozzle 50 has an outlet that is arranged and configured so that the fluid that is discharged through the outlet is dispersed into a spray pattern 51 in the form of a substantially flat sheet of the fluid that is located in a plane that intersects at an angle of other than ninety degrees a plane containing both the axis of rotation 13 of the rotatable spray device and the arm 14 supporting the fourth nozzle. This is accomplished by providing a nozzle that has an elongated slot and positioning the nozzle so that the slot directs the fluid discharged therefrom generally transversely to the radial aspect of the axis of rotation of the rotatable spray device 10 that extends along arm 14. In the case of the fourth nozzle in the embodiment of the invention shown in the drawings, no outlet is provided for the purpose of establishing a spray pattern of the fluid that is in the form of a three-dimensional sheet but such an outlet can be included with the fourth nozzle if desired.

Techniques for supplying the fluid to the nozzles are known to those skilled in the art. In the embodiment of the invention shown in the drawings, as described, passageways are provided in the spray arms and these passageways are in fluid communication with a source of the fluid that enters the passageways at the hub 11. As described, appropriate closure means, not shown, cover the passageways so that the fluid is confined to the passageways as it flows to the nozzles supported by the spray arms.

The foregoing description of the invention is intended to enable a person skilled in the art to practice the invention. It is not intended to detail all the possible modifications and variations that will be apparent to those skilled in the art upon reading the description with reference to the drawings. For example, a rotary spray device having two spray arms is not required. A spray device having more than two arms or having only one arm can be used. Further, the precise arrangement of the nozzles on the spray arms is subject to modification. It is intended that all modifications and variations be included within the scope of the invention as defined in the claims below.

1: An appliance for washing articles including:
an enclosure for containing the articles;
means for supplying a fluid under pressure;
a spray device for distributing the fluid to the articles located within the enclosure and in fluid communication with the means for supplying fluid under pressure, the spray device including at least one arm;
a first nozzle supported from the at least one arm of the spray device and adapted to receive a fluid to be discharged through the first nozzle for distribution;
the first nozzle having a first outlet from which the fluid is discharged, the first outlet being configured so that the fluid as it is discharged from the first outlet is disseminated into a spray pattern in the form of a three-dimensional sheet of the fluid.

2: The appliance for washing articles of claim 1 wherein the first outlet is configured so that the fluid as it is discharged from the first outlet is disseminated into a spray pattern generally in the form of a portion of a substantially hollow cone with the apex of the cone being located at the first outlet.

3: The appliance for washing articles of claim 1 wherein:
the first outlet includes a first outlet opening through which the fluid is discharged, the first outlet opening having a first end and a second end, the first end of the first outlet opening being wider than the second end;
a confining surface is located opposite the first outlet opening for confining the fluid to the first outlet opening; and
the first nozzle is adapted to receive the fluid in a manner such that the fluid is directed from the first end of the first outlet opening to the second end of the first outlet opening.

4: The appliance for washing articles of claim 3 wherein the first outlet opening is incrementally and uniformly narrower in a direction from the first end of the first outlet opening to the second end of the first outlet opening.

5: The appliance for washing articles of claim 4 wherein the confining surface is concave and generally conically-shaped.

6: The appliance for washing articles of claim 5 wherein the first outlet is configured so that the fluid as it is discharged through the first outlet opening is disseminated into a spray pattern generally in the form of a portion of a substantially hollow cone with the apex of the cone being located at the first outlet opening.

7: The appliance for washing articles of claim 6 wherein the first nozzle includes a concave generally cylindrically-shaped passageway that is joined to the first end of the confining surface so as to be in fluid communication with the first outlet.

8-14. (canceled)

15: An automatic dishwasher including:
an enclosure for containing articles to be washed;
a rack for holding articles to be washed mounted within the enclosure adjacent the upper wall of the enclosure;
means for supplying a fluid under pressure;
a rotatable spray device mounted for rotation about an axis of rotation above the rack for holding the articles to be washed, the rotatable spray device being in fluid communication with the means for supplying a fluid under pressure and including at least one arm extending outwardly from the axis of rotation of the spray device;
a first nozzle supported from the at least one arm of the rotatable spray device and adapted to receive a fluid to be discharged through the first nozzle for distribution;
the first nozzle having a first outlet from which the fluid is discharged, the first outlet being configured so that the fluid as it is discharged from the first outlet is disseminated into a spray pattern in the form of a three-dimensional sheet of the fluid.

16: The automatic dishwasher of claim 15 wherein the first outlet is configured so that the fluid as it is discharged from the first outlet is disseminated into a spray pattern generally in the form of a portion of a substantially hollow cone with the apex of the cone being located at the first outlet.

17: The automatic dishwasher of claim 15 wherein:
the first outlet includes a first outlet opening through which the fluid is discharged, the first outlet opening having a first end and a second end, the first end of the first outlet opening being wider than the second end,
a confining surface is located opposite the first outlet opening for confining the fluid to the first outlet opening; and
the first nozzle is adapted to receive the fluid in a manner such that the fluid is directed from the first end of the first outlet opening to the second end of the first outlet opening.

18: The automatic dishwasher of claim 17 wherein the first outlet opening is incrementally and uniformly narrower in a direction from the first end of the first outlet opening to the second end of the first outlet opening.

19: The automatic dishwasher of claim 18 wherein the confining surface is concave and generally conically-shaped.

20: The automatic dishwasher of claim 19 wherein the first outlet is configured so that the fluid as it is discharged through the first outlet opening is disseminated into a spray pattern generally in the form of a portion of a substantially hollow cone with the apex of the cone being located at the first outlet opening.

21: The automatic dishwasher of claim 20 wherein the first nozzle includes a concave generally cylindrically-shaped passageway that is joined to the first end of the confining surface so as to be in fluid communication with the first outlet.

22-36. (canceled)
